(19) United States
(12) Patent Application Publication
(10) Pub. No.: US 2003/0218390 A1
(43) Pub. Date: Nov. 27, 2003

(54) Voice-coil motor for picking up chips

(76) Inventors: Story Huang, Hsinchu Hsien (TW); Chun-Hsien Liu, Taipei (TW); Szu-Hui Lee, Taichung Hsien (TW); Yvonne Chang, Hsinchu Hsien (TW); Hung-I Lin, Pingtung Hsien (TW); Jia-Bin Hsu, Yunlin Hsien (TW)

Correspondence Address: BIRCH STEWART KOLASCH & BIRCH, PO BOX 747, FALLS CHURCH, VA, 22040-0747, US

(21) Appl. No.: 10/151,978

(22) Filed: May 22, 2002

(51) Int. Cl. H02K 41/00

(52) U.S. Cl. 310/12

(57) ABSTRACT

A voice-coil motor for picking up chips is disclosed. Through the electromagnetic force generated from the voice-coil motor, the invention can accurately control its strength when picking up a chip. The procedure of picking a chip is as follows: first, a chip is separated from a blue film due to the force of a rising ejectpin; then a pickup head is used to suck the chip to an assigned place. In particular, when the ejectpin pushes the chip up, the pickup head is controlled to rise together with the ejectpin so that the ejectpin also raises the pickup head. Through the above-mentioned control, the stress on the chip can be reduced, preventing the chip from being broken.

### BACKGROUND OF THE INVENTION

1. Field of Invention

The invention relates to a chip picking mechanism and, in particular, to a voice-coil motor for picking up chips.

2. Related Art

The conventional chip picking mechanism mainly uses the force due to a rising ejectpin to separate the chip from the blue film. A pickup head is then used to suck the chip to an assigned place. During this process, however, the pickup head cannot control to rise together with the ejectpin when the ejectpin pushes the chip upwards. The ejectpin has to push the pickup head too. Thus, the chip undertakes the extra burden from the pickup head.

The explicit operations are shown in FIGS. 1A to 1D. Such a conventional chip picking mechanism utilizes a spring to control the pickup head for picking up chips. The state of the pickup head 10 before action is shown in FIG. 1A. When it starts its action, the pickup head 10 lowers down to the surface of the chip 20, as shown in FIG. 1B. Afterwards, the ejectpin 30 goes up to separate the chip 20 from the blue film 40. This process requires the spring force of the spring 11, as shown in FIG. 1C. Finally, the pickup head 10 uses the vacuum force at its tip to hold and raise the chip 20, as shown in FIG. 1D.

In fact, this kind of picking action cannot accurately control the strength. Moreover, since the force is mechanical (positive spring force), the force to pick up the chip is nonlinear. Therefore, it is not easy to control.

In the precision semiconductor industry, chips are thinner and smaller. Conventional chip picking mechanisms are therefore not sufficient in use. That is, once the picking force cannot be accurately controlled, the chip may be broken or have cracks. It is thus highly desirable to design a mechanism that is able to accurately control the force for picking chips.

### SUMMARY OF THE INVENTION

In view of the foregoing, the invention provides a voice-coil motor for picking up chips. The motor is designed to accurately control the force imposed on the chips through a magnetic force, preventing the chips from being broken during the process.

To achieve the above objective, the disclosed voice-coil motor contains: a yoke support, an annular magnet, a moving coil, a first linear bearing, positioning pins, stop pins, a main axis, a fixture cover, a pickup head, a connection axis, and a second linear bearing. The annular magnet is used to generate homogeneous closed magnetic lines. The yoke support connects and holds on to the annular magnet. The moving coil is coiled between the annular magnet and the yoke support for generating a magnetic force by allowing a current to flow through. The fixture cover is used to fix the moving coil. The main axis and the fixture cover are connected. When the moving coil generates a force, it makes vertical motion relative to the yoke support. Its top is installed with an air-pressure connector for producing an air pressure difference. The pickup head is connected to the bottom of the main axis for sucking the chip pump under the generated air pressure difference. The positioning pins are installed inside the fixture cover and the yoke support for limiting the downward motion of the main axis and to prevent the fixture cover from spinning.

Furthermore, the yoke support can be installed with a linear bearing for guiding the moving direction of the main axis. An additional stop pin can be installed on the yoke support as the stop point of the positioning pin.

### BRIEF DESCRIPTION OF THE DRAWINGS

The invention will become more fully understood from the detailed description given hereinbelow illustration only, and thus are not limitative of the present invention, and wherein:

FIGS. 1A to 1D are schematic diagrams showing the procedure of picking a chip in the prior art that uses springs as pickup heads;

FIG. 2 is a schematic view of the disclosed voice-coil motor structure;

FIG. 3A shows the force output in the prior art;

FIG. 3B shows the force output of the invention;

FIG. 4A shows the appearance of the voice-coil motor in the first embodiment;

FIG. 4B shows a quarter cross-section of the voice-coil motor in the first embodiment;

FIG. 5A shows the appearance of the voice-coil motor in the second embodiment;

FIG. 5B shows a quarter cross section of the voice-coil motor in the second embodiment; and

FIGS. 6A to 6D are schematic views showing the procedure of picking a chip using the disclosed voice-coil motor.

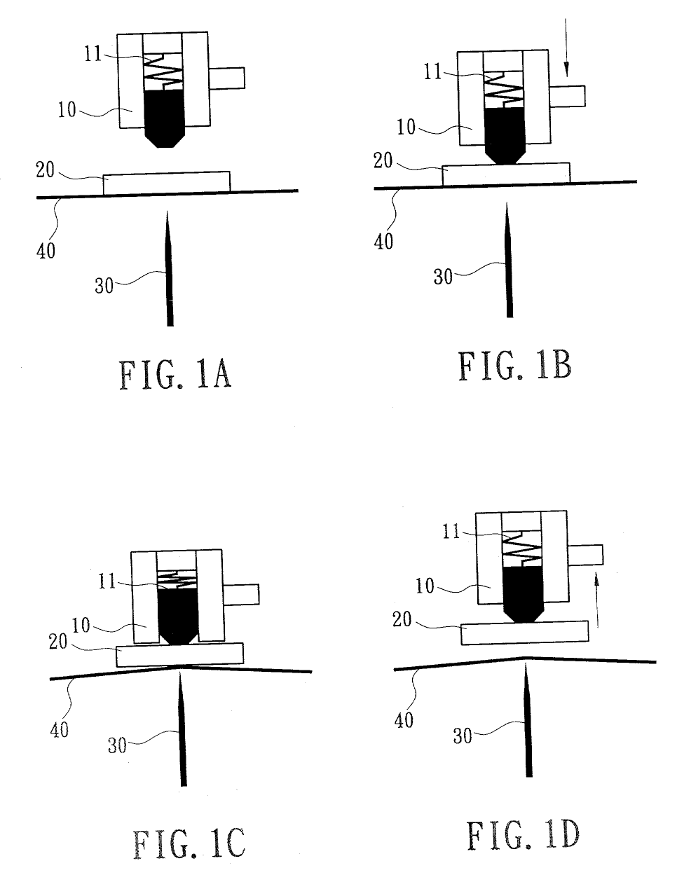

### DETAILED DESCRIPTION OF THE INVENTION

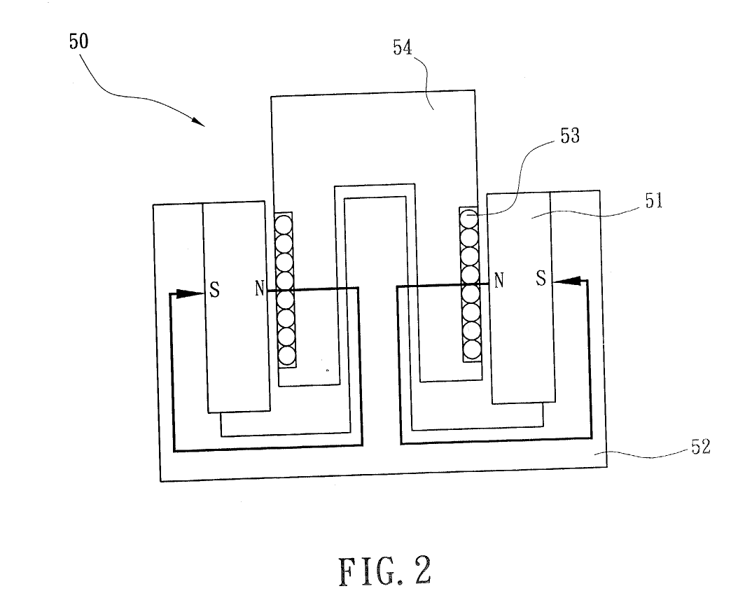

The voice-coil motor 50 according to the invention is shown in FIG. 2. An annular magnet 51 is fixed on a yoke shell 52, generating homogeneous closed magnetic lines, as indicated by the arrows. A coil 53 is fixed on a coil base 54, placed inside the annular magnet 51. When there is a current flowing perpendicular to the magnetic flux, a vertical force is generated.

According to the Fleming's Left Hand Rule, the magnetic force generated by the voice-coil motor is F=N×I×L×B, where N is the number of turns of the coil, I is the current flowing through the coil, B is the magnetic field, and L is the effective length. Therefore, the force generated by the voice-coil motor varies with the current, the number of coil turns, and the magnetic field. Since the number of turns of the coil 53 and the magnetic field of the annular magnet are both fixed, only the current is an adjustable variable. The invention changes the magnitude of the magnetic force by varying the current. Reversing the current flowing direction (reversing charge poles) can generate forces in the opposite direction.

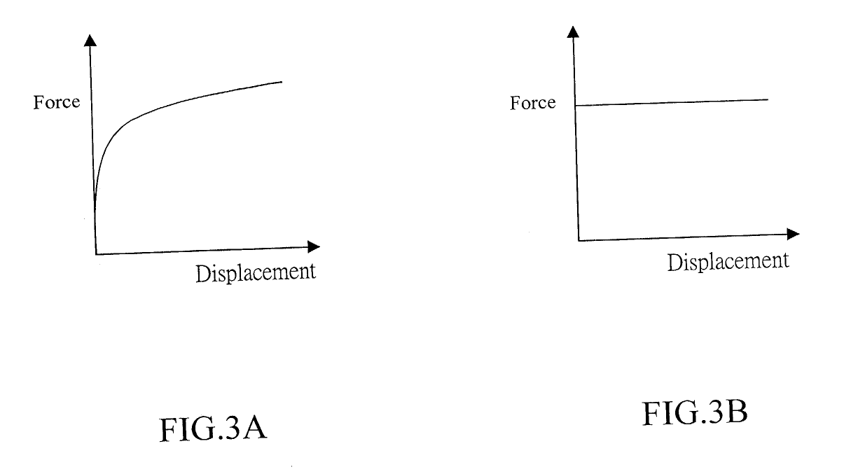

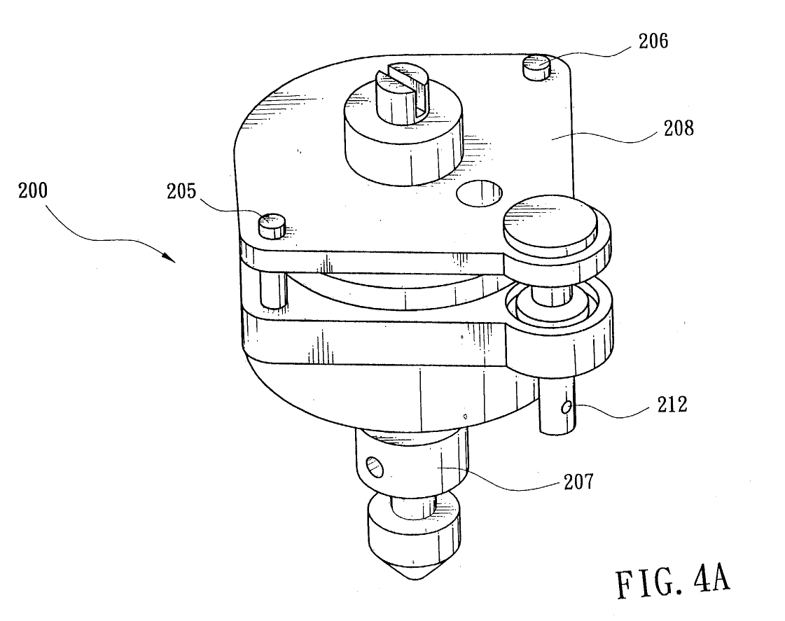

FIG. 3A and FIG. 3B show the relation between the output force and the displacement in a conventional pickup head that uses a spring and the disclosed pickup head that uses a voice-coil motor as the picking mechanism, respectively. As seen in FIG. 3, the picking force of the invention is a constant in the distance. Therefore, it has a better picking performance.

On the other hand, the voice-coil motor utilizes an annular magnet and, therefore, one has to take into account the problem of the generation of a rotational torque by the voice-coil motor. To avoid the voice-coil motor from rotating due to the generated rotational torque, it is necessary to provide a rotation-free mechanism. We use two embodiments hereinafter to illustrate the invention.

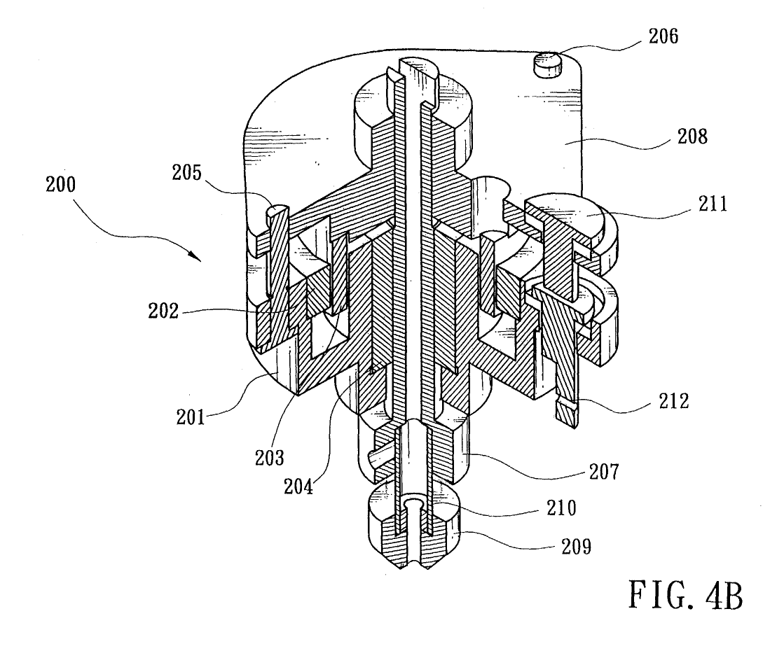

FIG. 4A shows a first embodiment of the voice-coil motor 200. From its appearance, one sees the rotation-free mechanism, which consists of a first positioning pin 205 and a second positioning pin 206, and a stop mechanism for the vertical motion of the motor, which consists of a stop pin 211 and a main axis 207. Please refer to FIG. 4B, a quarter cross-section of the first embodiment, for a more detailed explanation. The main parts of the first embodiment include: a yoke support 201, an annular magnet 202, a moving coil 203, a linear bearing 204, a first positioning pin 205, a second positioning pin 206, a main axis 207, a fixture cover 208, a pickup head 209, a connection axis 210, a first stop pin 211, and a second stop pin 212.

The annular magnet 202 is installed on the yoke support 201 to generate homogeneous closed magnetic field lines in the yoke support 201. The moving coil 203 coils between the annular magnet 202 and the yoke support 201, and combines with the fixture cover 208. When the moving coil 203 is imposed with an electric current, its flowing direction is perpendicular to the magnetic field lines generated by the magnet 202, generating a force parallel to the moving direction. This force drags the moving coil 203 and the fixture cover 208 to make vertical motion. Moreover, the invention accurately controls the output force by tuning the input current, offering a standard linear output force. This output force control can be achieved through a current control module.

The main axis 207 has an air-pressure connector is provided at its top and is connected to a pickup head 209 through a connection axis 210. Through the air pressure difference generated by the air pressure connector, the pickup head can pick up or put down a chip. The main axis 207 and the fixture cover 208 are connected by a screw. Therefore, when the moving coil 203 is provided with a current and generates a force, the force is also imposed on the main axis and the fixture cover. When the stress on the chip is greater than the force generated by the coil, the main axis 207 rises. Since it has the property of a negative spring, the force imposed on the chip becomes smaller when the main axis 207 ascends, preventing the chip from being broken due to the stress. The first and second positioning pins 205, 206 are used to guide the vertical motion of the fixture cover without making rotations. The linear bearing 204 is fixed on the yoke support 201, guiding the main axis 207 to make vertical motion without too much friction.

The first stop pin 211 is installed on the fixture cover 208, whereas the second stop pin 212 is installed on the second stop pin 212. The first stop pin 211 and the second stop pin 212 are designed to limit the vertical motion range of the moving coil 203, the fixture cover 208, and the main axis 207. The bottom of the main axis 207, the first stop pin 205, and the second stop pin 206 are all provided with stop mechanisms to restrict the upward motion of the main axis. Such a design can protect the whole structure from falling apart.

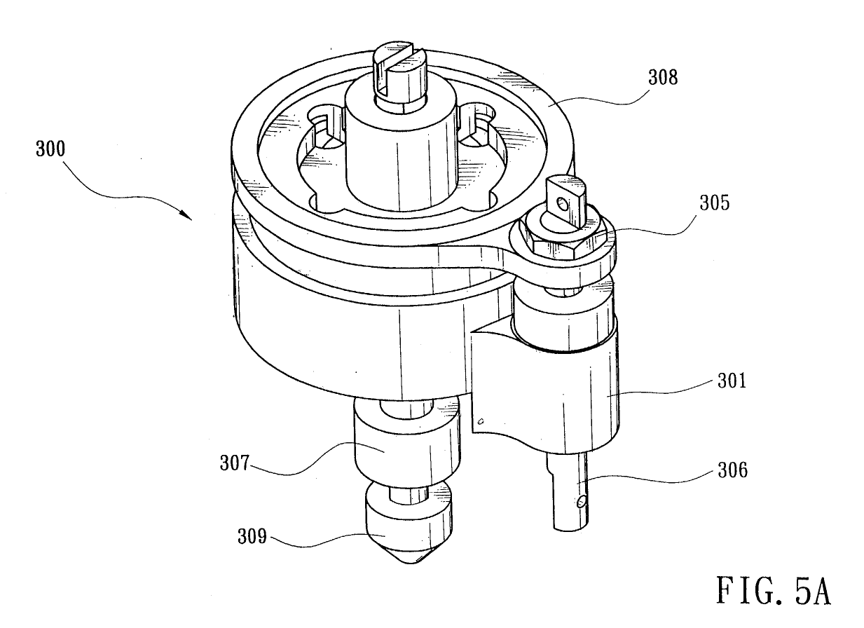

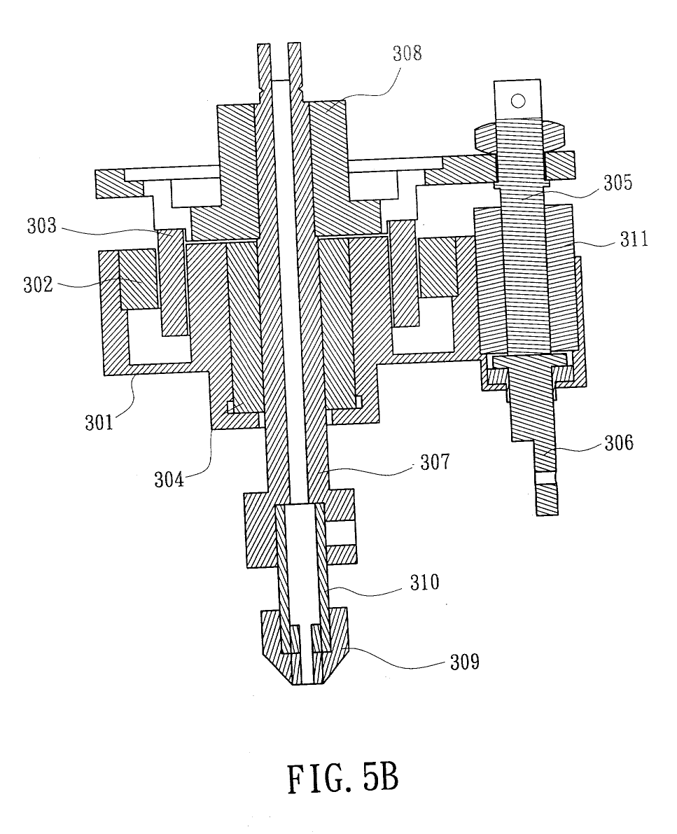

With reference to FIG. 5A, the second embodiment of the invention has a simpler voice-coil motor structure 300. The rotation-free mechanism and the downward motion stop mechanism are combined together, i.e. the positioning pin 305 and the stop pin 306. Similarly, the upward motion stop mechanism of the motor is achieved with the help of the main axis 307. A detailed cross section is shown in FIG. 5B. Essential parts include: a yoke support 301, an annular magnet 302, a moving coil 303, a first linear bearing 304, a positioning pin 305, a stop pin 306, a main axis 307, a fixture cover 308, a pickup head 309, a connection axis 310, and a second linear bearing 311.

Comparing FIGS. 4A, 4B with FIGS. 5A, 5B, one easily sees that the main difference between the second embodiment and the first embodiment is on the design of the positioning pins and the stop pins. The first embodiment employs the design of separate positioning pins and stop pins, whereas the second embodiment combines both types of pins together as one. That is, a single positioning pin 305 can achieve both the stopping and positioning functions. Moreover, the later embodiment has the second linear bearing 311 installed on the yoke support 301 for guiding the vertical motion of the positioning pin 305 and reducing the friction. The rest parts in the second embodiment are the same as in the first embodiment and, therefore, are not explained again.

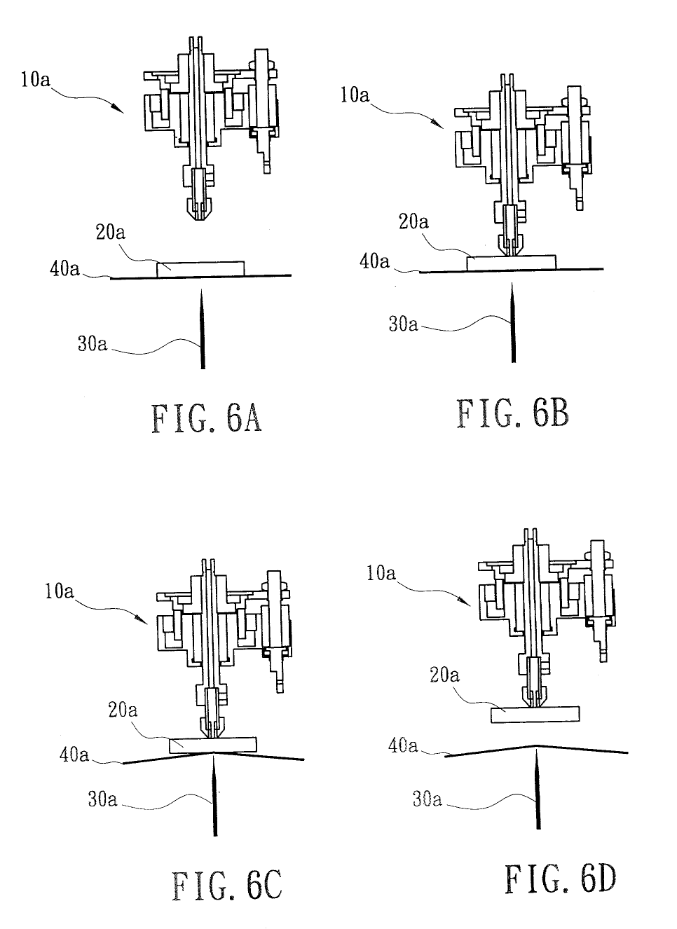

Finally, please refer to FIGS. 6A through 6D. FIG. 6A shows the state of the motor before action. In FIG. 6B. the voice-coil motor 10a lowers to the surface of a chip 20a. Afterwards, the ejectpin 30a rises to separate the chip 20a from the blue film 40a. At the moment, the voice-coil motor 10a uses its negative spring force to absorb the force from the rising ejectpin 30a, as shown in FIG. 6C. Finally, the pickup head of the voice-coil motor 10a sucks the chip 20a using the vacuum at its tip and rises to pick up the chip 20a, as shown in FIG. 6D.

### EFFECTS OF THE INVENTION

Using the disclosed voice-coil motor can accurately control the picking force, preventing the chip from being broken during the picking process. This is because the stress on the chip is reduced.

The invention uses a magnetic force to control the force imposed on the chip by the pickup head. It has the advantages of being able to accurately controlling the force, having a standard linear output, being easy to control and acting like a negative spring.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A voice-coil motor for picking chips, which comprises:
an annular magnet for generating homogeneous closed magnetic field lines;
a yoke support connected to and fixing the annular magnet;
a moving coil surrounding between the annular magnet and the yoke support for generating a force when an electric current flows through the moving coil;
a fixture cover for fixing the moving coil;
a main axis connected to the fixture cover for making vertical motion relative to the yoke support when the moving coil generates the force, the top of the main axis being installed with an air-pressure connector for producing an air pressure difference;
a pickup head connected to the bottom of the main axis for picking a chip using the sucking force from the air pressure difference generated by the air-pressure connector; and
a positioning pin installed inside the fixture cover and the yoke support for restricting the downward motion of the main axis and preventing the fixture cover from rotation.

2. The voice-coil motor of claim 1, further comprising a first linear bearing fixed in the yoke support for guiding the main axis to make vertical motion and reducing friction thereof.

3. The voice-coil motor of claim 2, further comprising a second linear bearing fixed in the yoke support for guiding the positioning pin to make vertical motion and reducing friction thereof.

4. The voice-coil motor of claim 1, further comprising a stop pin installed on the yoke support for stopping the downward motion of the positioning pin when they get into contact.

5. The voice-coil motor of claim 1, further comprising a connection axis for connecting the main axis with the pickup head.

6. The voice-coil motor of claim 1, wherein the main axis contains an upward motion restriction mechanism installed at the bottom of the main axis.

7. A voice-coil motor for picking chips, which comprises:
an annular magnet for generating homogeneous closed magnetic field lines;
a yoke support connected to and fixing the annular magnet;
a moving coil surrounding between the annular magnet and the yoke support for generating a force when an electric current flows through the moving coil;
a fixture cover for fixing the moving coil;
a main axis connected to the fixture cover for making vertical motion relative to the yoke support when the moving coil generates the force, the top of the main axis being installed with an air-pressure connector for producing an air pressure difference;
a pickup head connected to the bottom of the main axis for picking a chip using the sucking force from the air pressure difference generated by the air-pressure connector;
at least a positioning pin, all installed inside the fixture cover and the yoke support for preventing the fixture cover from rotation; and
a stop pin installed on the fixture cover for restricting the downward motion of the main axis.

8. The voice-coil motor of claim 7, further comprising a first linear bearing fixed in the yoke support for guiding the main axis to make vertical motion and reducing friction thereof.

9. The voice-coil motor of claim 7, further comprising a connection axis for connecting the main axis with the pickup head.

10. The voice-coil motor of claim 7, wherein the main axis contains an upward motion restriction mechanism installed at the bottom of the main axis.

11. The voice-coil motor of claim 7, wherein each of the positioning pins contains an upward motion restriction mechanism installed at the bottom of the positioning pin.
